(19) United States
(12) Patent Application Publication
(10) Pub. No.: US 2026/0037312 A1
(43) Pub. Date: Feb. 5, 2026

(54) CLOUD-BASED COMMITMENT BALANCING

(71) Applicant: CAST AI Group, Inc., Miami, FL (US)

(72) Inventors: Marius Jurkstas, Vilnius (LT); Mindaugas Mazalskis, Vilnius (LT)

(21) Appl. No.: 18/946,785

(22) Filed: Nov. 13, 2024

Related U.S. Application Data
(60) Provisional application No. 63/678,668, filed on Aug. 2, 2024.

(51) Int. Cl. G06F 9/50

(52) U.S. Cl. CPC G06F 9/5027

(57) ABSTRACT

A system or method for optimizing cloud computing resource utilization in Kubernetes environments. The system allocates different types of cloud resources to different clusters in a cloud environment based on priorities of the clusters. The different types of cloud resources include pre-committed instances and dynamic instances. The system tracks utilization of the pre-committed instances to determine whether the pre-committed instances are underutilized. Responsive to determining that the pre-committed instances are underutilized, the system rebalances clusters between the pre-committed instances and the dynamic instances based on priorities of the clusters. The rebalancing the clusters includes migrating at least one cluster from dynamic instances to underutilized pre-committed instances.

### CROSS REFERENCE TO RELATED APPLICATION

This application claims priority to U.S. Provisional Patent Application Ser. No. 63/678,668, filed Aug. 2, 2024, which is incorporated herein by reference in its entirety.

### TECHNICAL FIELD

This disclosure relates generally to cloud computing, and more specifically resource management in cloud environments.

### BACKGROUND

Cloud service providers offer pre-committed resources (also referred to as pre-committed instances) and dynamic resources, such as on-demand instances and spot instances. Pre-committed resources refer to cloud compute resources that an entity commits to utilizing in advance, typically for an extended period (e.g., 1 to 3 years). These resources are reserved for the entity over the specified period, and the entity is expected to manage and utilize them according to its operational needs. The downside is that these resources remain allocated regardless of actual usage, meaning they may go underutilized if the entity's demand fluctuates.

Dynamic instances do not require a commitment and can be allocated in near real-time based on demand and availability. Generally, there are two types of dynamic instances: on-demand instances and spot instances. On-demand instances are cloud compute resources that can be acquired as needed without long-term commitments. These resources enable entities to dynamically scale their infrastructure based on current workload requirements, offering a high level of flexibility in managing cloud resources.

Spot instances are cloud compute resources made available when there is excess capacity. These instances are allocated on a temporary basis and may be interrupted if the cloud provider reallocates the capacity to other tasks. Spot instances are suitable for workloads that are not time-sensitive and can tolerate interruptions, making them ideal for background processes or batch jobs.

Entities often allocate a portion of their clusters as pre-committed instances. However, if workload demands decrease, these resources may become unused. Conversely, entities may use on-demand or spot instances when workload demands increase. In some cases, pre-committed instances can be underutilized while on-demand or spot instances are still in use, leading to inefficiencies.

### SUMMARY

Embodiments described herein solve the above described problem by dynamically balancing pre-committed instances and dynamic instances based on utilization of the pre-committed instances.

In some embodiments, a system allocates different types of cloud resources to different clusters in a cloud environment (e.g., a Kubernetes environment) based on priorities of the clusters. The different types of cloud resources include pre-committed instances and dynamic instances, such as on-demand instances and spot instances. The system tracks utilization of the pre-committed instances to determine whether the pre-committed instances are underutilized. Responsive to determining that the pre-committed instances are underutilized, the system rebalances the clusters between the pre-committed instances and dynamic instances based on priorities of the clusters. Rebalancing the clusters includes migrating at least one cluster from the dynamic instances to the underutilized pre-committed instances, thereby releasing at least a portion of previously allocated dynamic instances.

In some embodiments, the system assigns a priority to each of the clusters. A first cluster with a higher priority is allocated to the pre-committed instances, and a second cluster with a lower priority is allocated to the dynamic instances. In some embodiments, assigning a priority to each of the clusters includes receiving a user input, indicating a priority a cluster, and assigning the cluster the priority indicated by the user input. In some embodiments, rebalancing clusters includes migrating a lower-priority cluster from the dynamic instances to the underutilized pre-committed instances.

In some embodiments, the system is further configured to automatically scale up or scale down a cluster based on workload demands of the cluster. Responsive to scaling up or scaling down the cluster, the system rebalances the clusters between the pre-committed instances and the dynamic instances based on the priorities of the clusters.

### BRIEF DESCRIPTION OF THE DRAWINGS

FIG. 1 illustrates an example environment in which a resource management system operates in accordance with one or more embodiments.

FIG. 2 illustrates an example architecture of a resource management system in accordance with one or more embodiments.

FIG. 3 illustrates an example of this hierarchy in a cloud environment in accordance with one or more embodiments.

FIG. 4 illustrates an example process of rebalancing clusters in a cloud environment in accordance with one or more embodiments.

FIG. 5 illustrates an example process of upscaling clusters in a cloud environment in accordance with one or more embodiments.

FIGS. 6A and 6B illustrate example graphical user interfaces (GUIs) that depict usage of different types of instances over a 24-hour period in accordance with one or more embodiments.

FIG. 7 is a flowchart of a method for rebalancing compute resources between pre-committed instances and dynamic instances, in accordance with one or more embodiments.

FIG. 8A is a flowchart of a method for autoscaling down a cluster in a pre-committed instances in accordance with one or more embodiments.

FIG. 8B is a flowchart of a method for autoscaling up a cluster in a pre-committed instances, in accordance with one or more embodiments.

FIG. 9 is a block diagram of an example computer suitable for use in a networked computing environment in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

Cloud service providers (clusters) offer three types of compute resources, namely pre-committed instances, on-demand instances, and spot instances. Pre-committed resources refer to cloud compute resources that an entity commits to utilizing in advance, typically for an extended period (e.g., 1 to 3 years). These resources are allocated to the entity for the specified period. The downside is that these resources remain allocated regardless of actual usage, meaning they may go underutilized if the entity's demand fluctuates. On-demand instances are cloud compute resources that can be acquired as needed without requiring long-term commitments. Spot instances are cloud compute resources made available when there is excess capacity. Spot instances are allocated on a temporary basis and may be interrupted if the cloud provider reallocates the capacity to other tasks.

Entities often allocate a portion of their clusters as pre-committed instances. However, if workload demands decrease, these resources may become unused. Conversely, entities may use on-demand or spot instances when workload demands increase. In some cases, pre-committed instances can be underutilized while on-demand or spot instances are still in use, leading to inefficiencies.

Embodiments described herein solve the above-described problem by monitoring usage of pre-committed instances and dynamically rebalancing clusters based in part on the usage of the pre-committed instances. In some embodiments, a resource management system allows for prioritization of clusters. High-priority clusters are allocated pre-committed instances first. Lower-priority clusters can be assigned spot instances or remaining instances during times of low demand.

Workload demands for each cluster may fluctuate due to various factors. For example, many user-facing applications experience traffic fluctuations at different times of the day as a result of user behavior. During the daytime, application demands typically increase because more people are active and using the services. This is often due to business hours, with professionals and consumers accessing applications for work, communication, shopping, or entertainment. The increased demand during the day can lead to higher loads on servers, networks, and computing resources. At night, demand usually decreases as fewer people are active. With fewer users, applications experience less traffic, resulting in reduced system loads.

This example illustrates one source of workload fluctuation, specifically related to day/night demand variations. In addition to these fluctuations driven by user behavior and regional time differences, other factors can also affect workload demands in a cloud or Kubernetes environment. These include seasonal demand, campaigns or promotions, unexpected events or news, economic factors, usage quotas, and/or billing cycles. These sources of fluctuation can similarly impact workload demands across clusters.

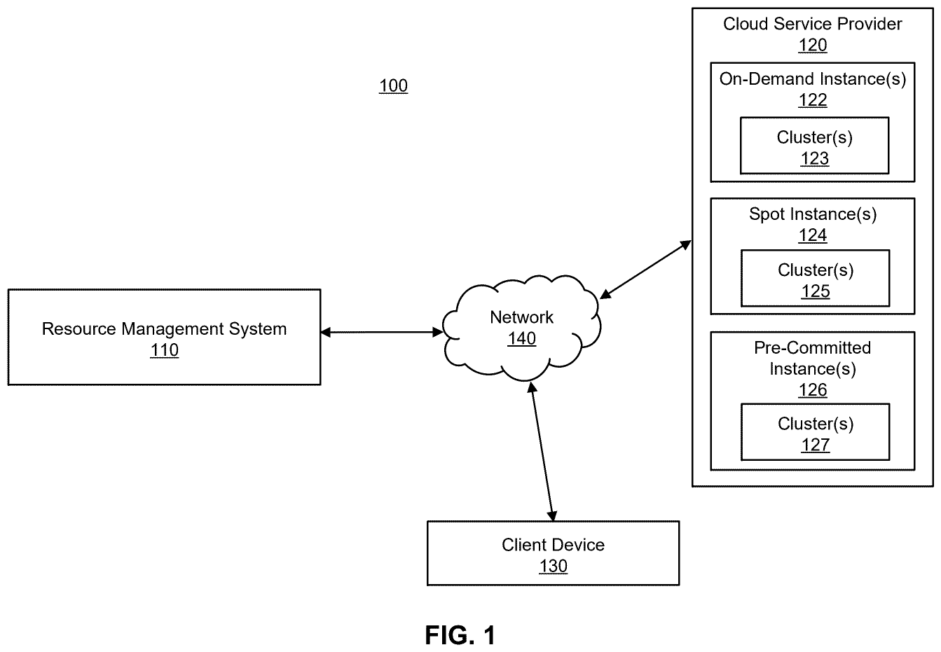

Additional details about the resource management system are further described below with respect to FIGS. 1-8.

### System Architecture

FIG. 1 illustrates an example environment 100 in which a resource management system 110 operates in accordance with one or more embodiments. In addition to the resource management system 110, the environment 100 further includes a cloud service provider 120, a client device 130, and a network 140. In alternative configurations, different and/or additional components may be included in the system environment 100. The cloud service provider may be (but is not limited to) Amazon Web Service (AWS), Microsoft Azure, and Google Cloud Platform (GCP). Each cluster 123, 125, 127 may include one or more nodes that work together as a single system to handle workloads and run applications.

Cloud service providers offer various cloud computing services or resources to entities, including pre-committed instances 126 and dynamic instances. Pre-committed instances 126 are allocated to the entity for the specified period. Dynamic instances do not require a commitment and can be allocated in near real-time based on demand and availability. Generally, there are two types of dynamic instances: on-demand instances 124 and spot instances 126. On-demand instances 122 are cloud compute resources that can be acquired as needed without requiring long-term commitments. Spot instances 124 are cloud compute resources made available when there is excess capacity.

A cluster is a set of nodes or instances that execute applications. In Kubernetes, a cluster runs containerized applications, and Kubernetes orchestrates and manages these containers across the cluster, ensuring that they run efficiently. The clusters 123, 125, 127 may be deployed using different types of compute including pre-committed instances 126, on-demand instances 122, spot instances 124, and/or a combination thereof, depending in part on priorities of the clusters and workload demands on the clusters. Each cluster 123, 125, 127 may include one or more interconnected nodes that work together as a single system to handle workloads and run applications. Because the workloads may be distributed across multiple nodes in a cluster 123, 125, 127, the cluster 123, 125, 127 can be scaled up or down based on workload demands. When any of the clusters 123, 125, 127 is scaled up, additional compute resources are provisioned, which may be from pre-committed instances, on-demand instances, spot instances, and/or a combination thereof. Note that although clusters 123, 125, and 127 are depicted as using a single type of compute resource, they may actually be provisioned using multiple types. For example, a cluster 127 may include five nodes, with three nodes provisioned from pre-committed instances 126, and the remaining two nodes provisioned from on-demand instances 122.

In some embodiments, the different clusters may be provisioned with compute resources from different cloud service providers (CSPs). For example, clusters could utilize resources from CSPs A through G, with a mix of instance types. Though any type of distribution is possible, as an example distribution, certain clusters might be provisioned with pre-committed instances from CSP A, on-demand instances from CSPs B through F, and spot instances from CSPs A and G. This distribution of resources across different CSPs allow for flexibility in managing compute availability and costs.

In this context, “scale up” or “scale down” refers to adjusting the number of computer resources allocated to a cluster based on their current workload or demand. Scaling up, when a cluster requires more computational power or capacity, additional resources (such as more compute instances or nodes) are provisioned to handle the increased workload. This could include adding pre-committed instances, on-demand instances, or spot instances to the cluster. On the other hand, if the demand decreases, and the workload reduces, a number of compute resources allocated to the cluster can be reduced.

In some embodiments, the clusters 123, 125, 127 are Kubernetes clusters, each of which includes a set of nodes that work together to run containerized applications. Additional details about clusters and Kubernetes services are described in U.S. patent application Ser. No. 17/380,729, filed Jul. 20, 2021 (now issued as U.S. Pat. No. 11,595,306), which is incorporated herein in its entirety.

The resource management system 110 determines types of compute resources that are provisioned for each cluster 123, 125, 127 at the time of deploying the clusters 123, 125, 127. The resource management system 110 also tracks the usage of the pre-committed instances 126 and based on the usage to rebalancing the clusters 123, 125, 127 between the different types of resources. For example, responsive to determining that the pre-committed instances 126 is under utilized, the resource management system 110 may migrate some clusters 123, 125 from the on-demand instances 122 or spot instances 124 to the pre-committed instances.

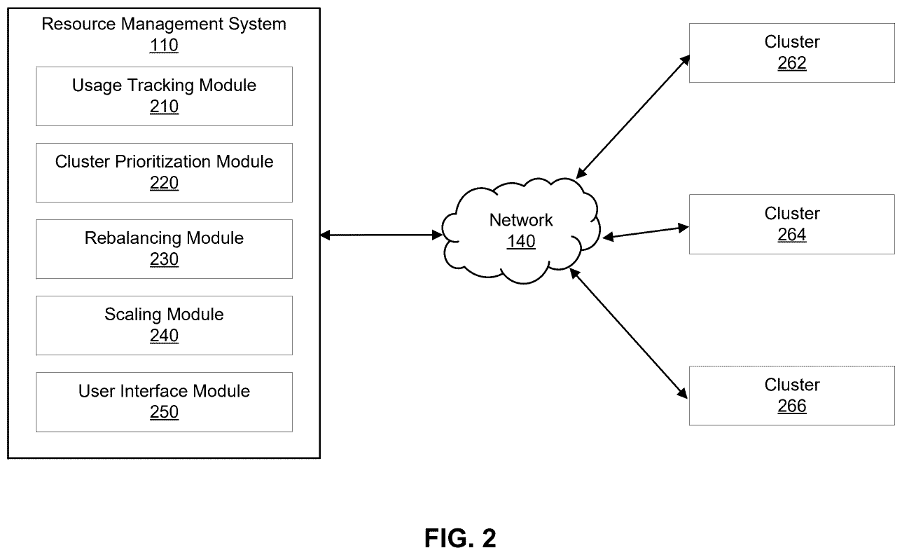

Further, the resource management system 110 may also scale the clusters based on workload demands on each of the clusters. When a cluster needs to be rescaled, the resource management system 110 also determines the type of resource to be used for the rescaling based in part on the usage of the pre-committed instances 126. For example, if the pre-committed instances 126 is underutilized, additional compute resources to be allocated to the upscaling cluster may be from the pre-committed instances. Additional details about the resource management system 110 are further described below with respect to FIG. 2.

FIG. 2 illustrates an example architecture of a resource management system 110 in accordance with one or more embodiments. The resource management system 110 includes a usage tracking module 210, a cluster prioritization module 220, a balancing module 230, an scaling module 240, and a user interface module 250. The usage tracking module 210 is configured to track usage of pre-committed instances.

In some embodiments, the cluster prioritization module 220 is configured to assign a priority to each cluster 262, 264, 266. In some embodiments, the priority may be assigned based on user input. Alternatively, or in addition, the priority may be automatically assigned based on predefined rules and time-sensitivities of workloads in the clusters. In some embodiments, each priority may correspond to a discrete level, such as high, medium, low. Alternatively, each priority may be represented by a numerical number, where a lower number indicates a higher priority, a higher number indicates a lower priority, or vice versa.

In some embodiments, pre-committed instances are initially allocated to higher-priority clusters. Any remaining compute resources from the pre-committed instances are then allocated to lower-priority clusters. If the higher-priority clusters exhaust all available pre-committed instances, dynamic instances are provisioned and allocated to the remaining clusters. In some embodiments, on-demand instances are provisioned and allocated to the remaining higher-priority clusters, while spot instances are provisioned and allocated to the remaining lower-priority clusters.

In some embodiments, the system may assign priorities to clusters based on the requirements and attributes of each cluster, such as a type of workload or application the cluster is supporting. For example, high-priority may be assigned to user-facing applications that require stability and minimal disruption, such as real-time services or financial transactions; low-priority clusters may be assigned to background jobs or workloads that can tolerate interruptions, such as data processing or batch analytics. In some embodiments, the priorities may be dynamically assigned based on traffic or load. For example, a high traffic cluster may be assigned a higher priority, and a lower traffic cluster may be assigned a lower priority. In some embodiments, the priority may be assigned based on service-level agreements (SLAs). Clusters supporting services with strict uptime or performance SLAs may be assigned a higher priority, and clusters with less critical SLAs may be assigned a lower priority.

Notably, when the clusters are initially deployed, the allocation of resources may be based on projected or peak workload demands. However, the actual workload demands of each cluster can fluctuate over time. These fluctuations may be influenced by factors such as user activities and seasonal or time-based demand. For instance, in a consumer-facing application, the cluster's workload typically peaks during the daytime and decreases at night.

The scaling module 240 monitors key metrics like CPU utilization, memory usage, network traffic, and/or application specific performance indicators (e.g., response time or queue length) to determine how much resource capacity is being used or needed. Responsive to determining that the monitored metrics exceed a predefined threshold (e.g., CPU usage above 80%), the scaling module 240 automatically adds more instances to handle the increased load. On the other hand, if the monitored metrics decreases to a predefined threshold (e.g., CPU usage below 40%), the scaling module 240 automatically reduces the number of instances.

The scaling up or down of any of the clusters 262, 264, 266 will result in the usage of pre-committed instances to fluctuate. The usage tracking module 210 is configured to monitor and track the usage of the pre-committed instances to determine whether the pre-committed instances are being fully utilized or underutilized.

The rebalancing module 230 is configured to balance clusters among the different types of compute resources, such as pre-committed instances, on-demand instances, and spot instances. In some embodiments, if the usage tracking module 210 detects that the pre-committed instances are underutilized, the rebalancing module 230 may migrate one or more clusters from on-demand or spot instances to the pre-committed instances to optimize resource utilization.

In some embodiments, the rebalancing module 230 may collaborate with the scaling module 240. When the scaling module 240 determines that a cluster needs to be scaled up (i.e., by adding one or more additional nodes), the rebalancing module 230 assesses whether these additional nodes should be provisioned from pre-committed instances 126, on-demand instances 122, or spot instances 124, ensuring efficient resource allocation. In some embodiments, the allocation of compute resources are based in part on the usage of instances and the priorities of the clusters. For example, if a low-priority cluster is to be upscaled, and the pre-committed instances are underutilized, the rebalancing module 230 may determine that additional nodes for the low-priority cluster should be provisioned from the pre-committed instances despite its low priority. As another example, if a high-priority cluster requires upscaling and the pre-committed instances are fully utilized, the rebalancing module 230 may decide to migrate some low-priority clusters from the pre-committed instances to spot instances. This migration frees up resources so that the additional nodes for the high-priority cluster can be provisioned from the pre-committed instances.

The user interface module 250 is configured to enable users to view the status of each cluster 262, 264, 266, as well as the utilization of different types of compute resources. Additionally, the module allows users to input configurations, such as setting priorities for clusters and/or initiating the migration of clusters between different types of compute resources. This provides users with comprehensive monitoring capabilities and the flexibility to manage cluster performance and resource allocation effectively.

### Hierarchical Compute Resources

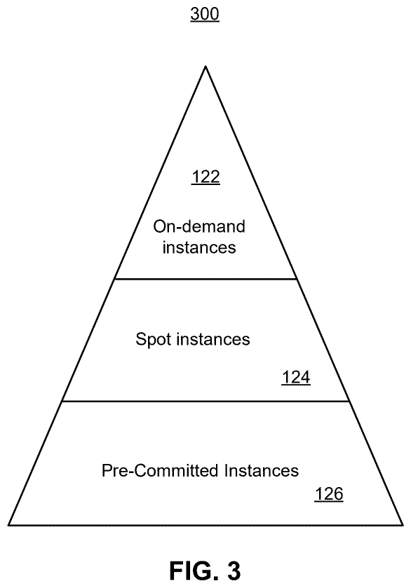

In some embodiments, the various types of compute resources are organized in a hierarchy. FIG. 3 illustrates an example of this hierarchy 300 in a cloud environment in accordance with one or more embodiments. The pyramid-shaped structure indicates that the bottom layer, which is also the largest, represents the majority of instances in use and the most desirable for utilization. In contrast, the top layer, being the smallest, represents the fewest instances in use and the least desirable option.

Pre-committed instances 126 (also referred to committed compute) is at a bottom layer. Pre-committed instances 126 are typically purchased for a long-term commitment, offering a guaranteed level of resource availability at a lower cost compared to other options. They are the most stable and reliable often used for critical, predictable workloads. In most cases, they are also the majority of instances in use.

Spot instances 124 is in the middle. Spot instances 124 are excess cloud capacity sold at a discounted rate, lower than pre-committed instances. However, these instances are less reliable than pre-committed instances, as they can be terminated by the cloud provider when the capacity is needed elsewhere. Spot instances are often used for flexible, non-critical workloads that can handle interruptions.

On-demand instances 122 are at the top level. On-demand instances 122 provide compute resources that can be provisioned and terminated as needed, without any long-term commitment. They offer flexibility but are the most expensive option.

Note, the pyramid structure presented here serves as an example hierarchy and does not require that pre-committed resources will always constitute the largest portion of a cluster. The distribution and utilization of instance types can vary significantly depending on the specific application requirements, workload characteristics, and cloud configuration. For some applications, a larger cluster might be placed on spot instances to optimize for cost, especially in flexible or transient tasks. In other cases, on-demand instances may be more prevalent, particularly where workloads are unpredictable, or resource availability is required on short notice. Ultimately, the hierarchy is flexible, and organizations can tailor their instance mix to align with their unique performance, reliability, and compute needs.

In some embodiments, the rebalancing module 230 and scaling module 240 allocate resources to clusters based on this hierarchy. For example, the rebalancing module 230 determines whether pre-committed instances have underutilized compute resources. If pre-committed instances have underutilized compute resources, the rebalancing module 230 or scaling module 240 allocates pre-committed instances to clusters. If all the pre-committed instances are fully used, the rebalancing module 230 considers spot instances, and then on-demand instances. However, since spot instances can be terminated with little notice, there may be frequent rebalancing between the spot instances 124 and on-demand instances 122, depending on the availability of the spot instances from the CSPs. In some embodiments, when spot instances become unavailable, high-priority workloads may be automatically migrated to on-demand instances 122 to maintain service continuity. Conversely, when spot instances 124 become available, workloads may be automatically migrated back from on-demand instances 122 to spot instances 124, or previously terminated low-priority workloads may be restarted. This ongoing rebalancing leverages spot instances when available, while minimizing disruption by transitioning to on-demand instances as needed. This dynamic resource management enables resource optimization without compromising system reliability.

### Example Rebalancing Process

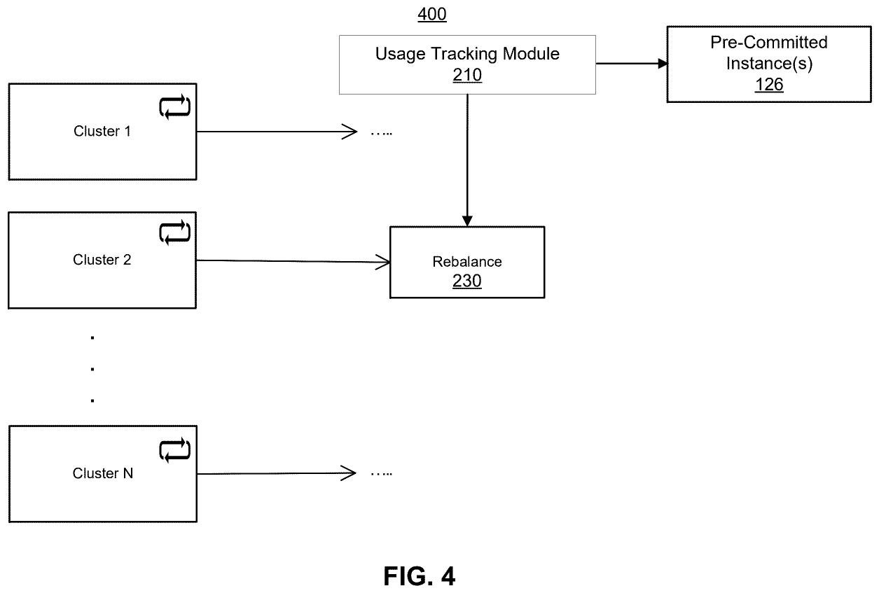

FIG. 4 illustrates an example process 400 of rebalancing clusters in a cloud environment in accordance with one or more embodiments. As illustrated, several clusters 411-41N are running. The usage tracking module 210 tracks the usage of the pre-committed instances 126. Responsive to determining that the pre-committed instances 126 are underutilized, the rebalancing module 230 migrates one or more clusters in spot instances or on-demand instances 126 to the pre-committed instances. For example, if the pre-committed instances 126 has sufficient capacity to provide compute resources for all the clusters 411-41N, these clusters 411-41N should all be migrated to the pre-committed instances 126.

However, if the pre-committed instances 126 have some capacity, but do not have enough capacity to provide compute resources for all the clusters 411-41N, the rebalancing module 230 may migrate some of the clusters based on priorities of the clusters 411-41N. In some embodiments, each of the clusters 411-41N is associated with a priority, e.g., high, medium, or low. In some embodiments, the high priority cluster(s) are migrated to the pre-committed instances 126, and the remaining low-priority cluster(s) may remain in spot-instances or on-demand instances.

Alternatively, the rebalancing module 230 may migrate some of the clusters based on the hierarchy shown in FIG. 2. The clusters in the on-demand instances have a higher priority to be migrated to the pre-committed instances first, then the clusters in the spot instances.

### Example Scale Upscaling Process

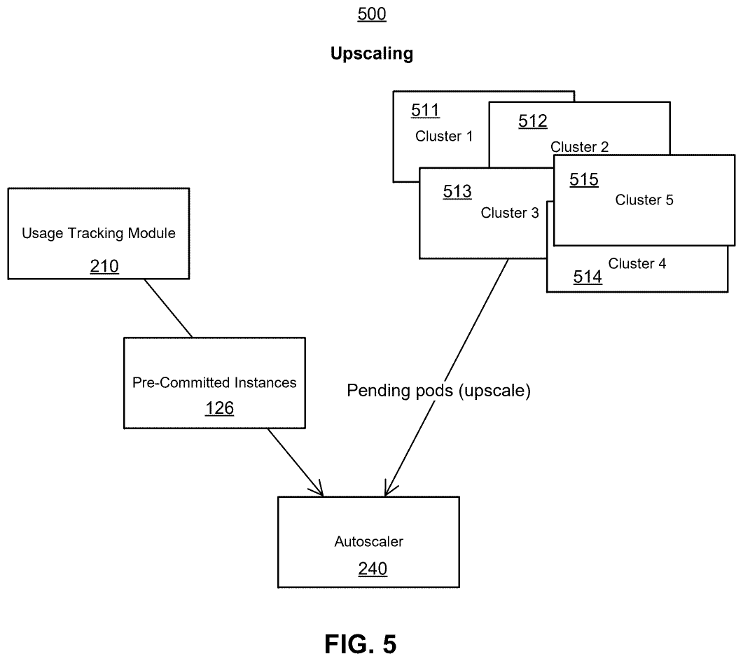

FIG. 5 illustrates an example process 500 of upscaling clusters in a cloud environment in accordance with one or more embodiments. The scaling module 240 dynamically adjusts the number of nodes in a cluster based on the resource demands of running workloads. In a Kubernetes environment, the scaling module 240 initiates a scale-up when unscheduled pods are present in the cluster. These pods cannot be placed on existing nodes due to insufficient CPU, memory, or other resources. The scaling module 240 identifies an appropriate instance type and size to accommodate these unschedulable pods and requests the cloud provider to add the nodes. These new nodes then join the cluster, allowing the unschedulable pods to be deployed.

Conversely, if certain nodes are underutilized—meaning they have low resource usage and no pending pods in the cluster—the scaling module 240 evaluates if all pods on these nodes can be safely relocated to other nodes without disrupting applications. If so, Kubernetes may initiate a “drain-and-move” process, allowing the removal of the underutilized node without affecting applications. During this process, the scaling module 240 drains the node by evicting or relocating all running pods to other nodes in the cluster with sufficient resources. In some embodiments, during eviction process, the scaling module 240 marks the node as unschedulable (e.g., sets it to NoSchedule) to prevent any new pods from being assigned to it. Once all pods have been successfully evicted and rescheduled, the node is removed from the cluster. In cloud environments, removing the node may include de-provisioning an underlying virtual machine, releasing it back to the cloud provider.

In some embodiments, the scaling module 240 may use metric-based scaling triggered based on resource utilization metrics (e.g., CPU or memory usage). In some embodiments, the scaling module 240 may scale up or down at predetermined times (e.g., increase resources during known peak hours). In some embodiments, the scaling module 240 may use historical data and machine learning to predict future demand and preemptively scale compute resources.

In some embodiments, the scaling module 240 works in conjunction with load balancing, which distributes traffic evenly across multiple instances. When new instances are added (scaled-up), the load balancer routes traffic to the new instances, ensuring that no single instance becomes overloaded.

As illustrated, several clusters 511-515 are pending upscale, meaning that additional compute resources need to be allocated to each of these clusters 511-515. The usage tracking module 210 tracks the usage of the pre-committed instances 126. The usage of the pre-committed instances 126 is sent to the scaling module 240. The scaling module 240 scales up the clusters 511-515 based in part on the usage of the pre-committed instances 126. For example, if the pre-committed instances has sufficient capacity to provide compute resources for all the clusters 511-515, these clusters 511-515 should all be allocated additional compute resources from the pre-committed instances 126.

However, if the pre-committed instances 126 have some capacity, but do not have enough capacity to provide compute resources for all the clusters 511-515, the scaling module 240 may allocate compute resources further based on priorities of the clusters 511-515. In some embodiments, each of the clusters 511-515 is associated with a priority, e.g., high, medium, or low. In some embodiments, the highest priority cluster(s) are allocated resources from the pre-committed instances 126, and the remaining low-priority cluster(s) are allocated resources from spot-instances.

### Example Graphical User Interfaces (GUI)

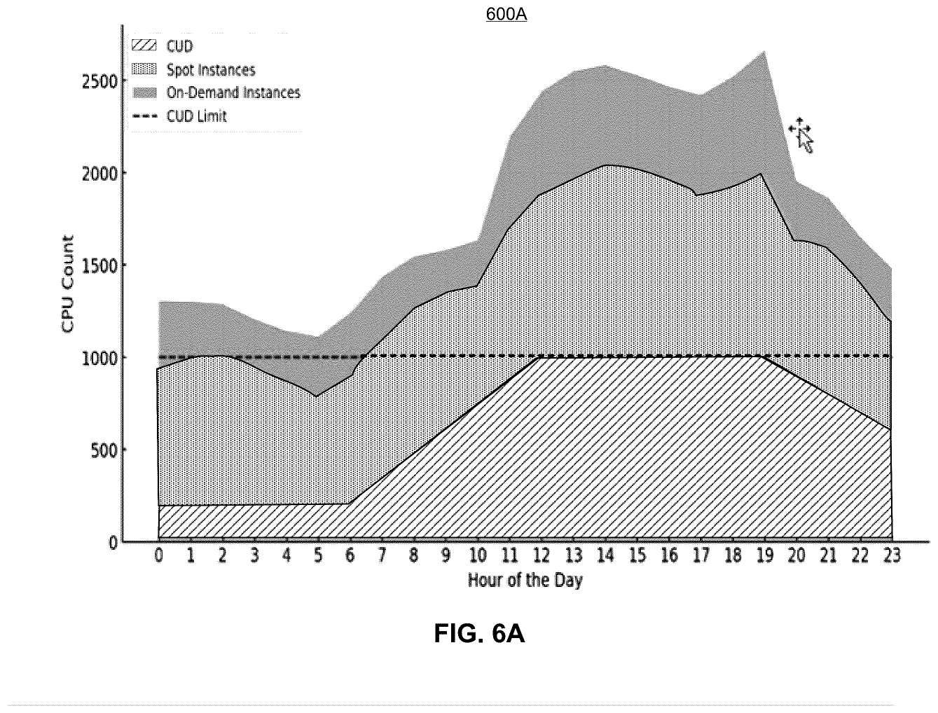

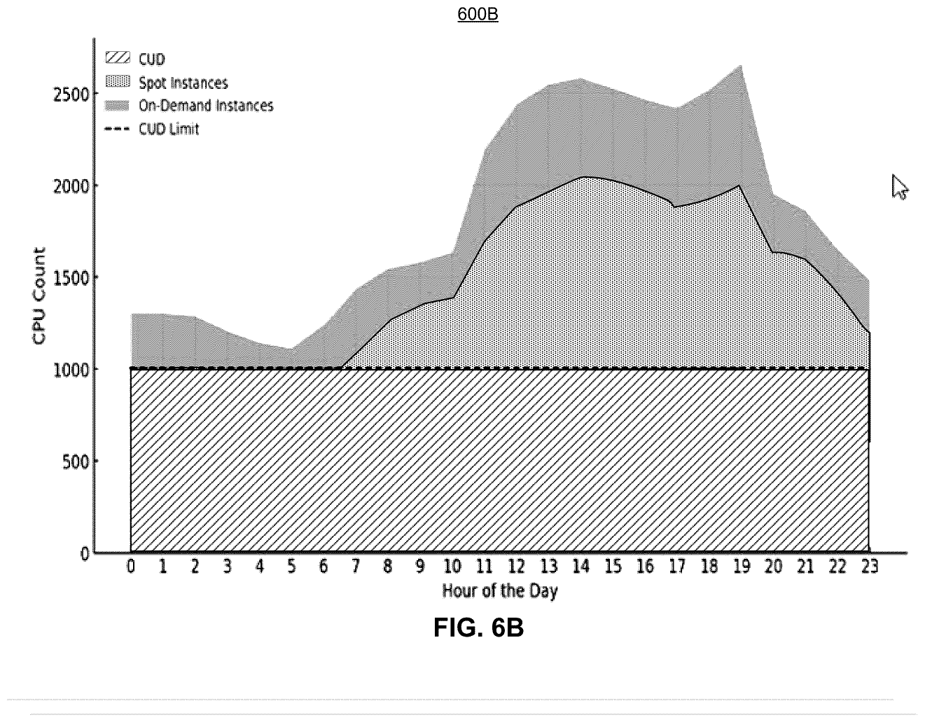

FIGS. 6A and 6B illustrate example graphical user interfaces (GUIs) that depict usage of different types of instances over a 24-hour period in accordance with one or more embodiments. Referring to FIG. 6A, the GUI 600A shows CPU count on the Y-axis and hour of the day on the X-axis. The GUI 600A illustrates how different types of compute resources pre-committed instances, spot instances, and on-demand instances are utilized throughout a day. Pre-committed instances has a limit of 1000 CPUs, which is the amount of CPUs an entity has committed with the cloud service provider. This 1000 CPUs will be provisioned regardless of whether they are fully utilized.

Based on FIG. 6A the usage of the pre-committed instances fluctuates during the day, increasing gradually from around 5 AM, peaking in the middle of the day (around 12 PM to 6 PM), and decreasing after 6 PM. Notably, between 0 AM and 6 AM, the pre-committed instances usage is far below the limit, indicating these pre-committed instances are far underutilized. As the day begins, between 6 AM to 12 PM there is a gradual increase in usage of pre-committed instances. During the afternoon, between 12 PM to 6 PM, the pre-committed instances are fully used. After 6 PM, the usage of the pre-committed instances decreases, the pre-committed instances are underused again. On the other hand, the usage of the spot instances and on-demand instances are more stable compared to that of the pre-committed instances.

GUI 600A illustrates a scenario where the rebalancing and autoscaling technologies described herein are not applied. In some embodiments, entities are given options to opt in or opt out of the rebalancing and autoscaling features described herein. In this case, the entity has not opted in these features. In some embodiments, pre-committed instances are assigned to certain high-priority clusters, while spot instances and on-demand instances are allocated to other clusters. These allocations may be determined by peak workload demands, with resources from pre-committed instances covering, for example, 85% of the peak workload demand. However, as the workload for clusters fluctuates throughout the day, a traditional system does not rebalance clusters between spot and on-demand instances. As a result, pre-committed instances may become underutilized, while spot and on-demand instances continue to be used and incur costs, leading to inefficient use of resources.

Referring to FIG. 6B, the GUI 600B illustrates a scenario when rebalancing and autoscaling described herein are applied to the clusters, in accordance with one or more embodiments. As illustrated, the pre-committed instances are fully utilized throughout the day, with spot instances and on-demand instances only handling the overflow workloads. This results in a significant reduction in the use of spot and on-demand instances, optimizing resource efficiency and lowering costs.

Note, the values illustrated in the GUIs 600A, 600B are merely exemplary and are not intended to limit the scope of the embodiments. For instance, the number of pre-committed CPUs can be configured to any number based on the specific needs of the application, with 1000 CPUs being used here as an example. Similarly, values for other resources, such as on-demand and spot instances, are also provided for illustrative purposes only and can be adjusted according to the system's demands. The flexibility in configuring these values allows for a wide range of resources allocations tailored to the needs of different applications.

Example Methods for Rebalancing and/or Autoscaling Clusters

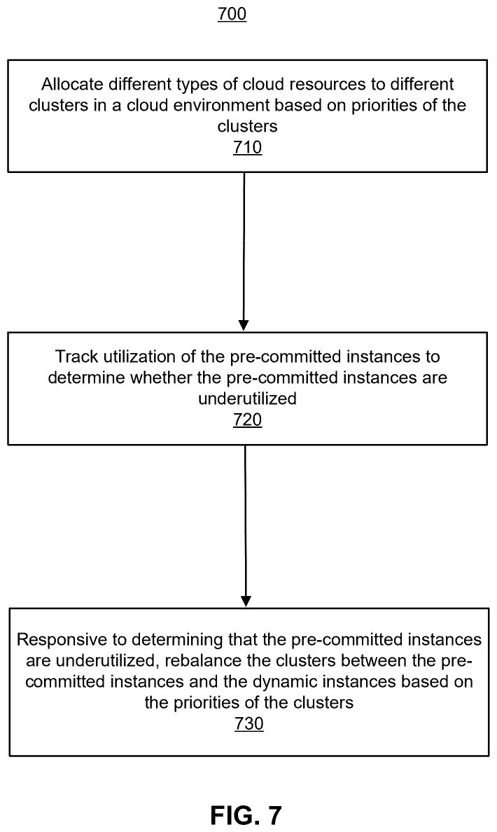

FIG. 7 is a flowchart of a method 700 for rebalancing compute resources between pre-committed instances and dynamic instances, in accordance with one or more embodiments. The method 700 may be performed by computing system, such as a resource management system 110. In some embodiments, the method 700 may include more or fewer steps than illustrated in FIG. 7, and the steps of the method do not need to follow any predetermined order.

The resource management system 110 allocates 710 different types of cloud resources to different clusters in a cloud environment (e.g., a Kubernetes environment) based on priorities of the clusters. The different types of cloud resources include pre-committed instances and dynamic instances, such as on-demand instances and spot instances.

The resource management system 110 tracks 720 utilization of the pre-committed instances to determine whether the pre-committed instances are underutilized. In some embodiments, the system 110 monitors key metrics such as CPU utilization of pre-committed instances. The resource management system 110 determines whether the pre-committed instances are underutilized based on the tracking. For example, in some embodiments, the system 110 may determine whether the utilization rate is lower than a predetermined threshold, such as 80%, the system 110 may determine that the pre-committed instances are underutilized.

Responsive to determining that the pre-committed instances are underutilized based on the tracking, the resource management system 110 rebalances 730 the clusters between the pre-committed instances and the dynamic instances based on the priorities of the clusters. Rebalancing the clusters includes migrating at least one cluster from the dynamic instances to the underutilized pre-committed instances, thereby releasing at least a portion of previously allocated dynamic instances.

In some embodiments, the system assigns a priority to each of the clusters. A first cluster with a higher priority is allocated to the pre-committed instances, and a second cluster with a lower priority is allocated to the dynamic instances. In some embodiments, assigning a priority to each of the clusters includes receiving a user input, indicating a priority a cluster, and assigning the cluster the priority indicated by the user input. In some embodiments, rebalancing clusters includes migrating a lower-priority cluster from the dynamic instances to the underutilized pre-committed instances.

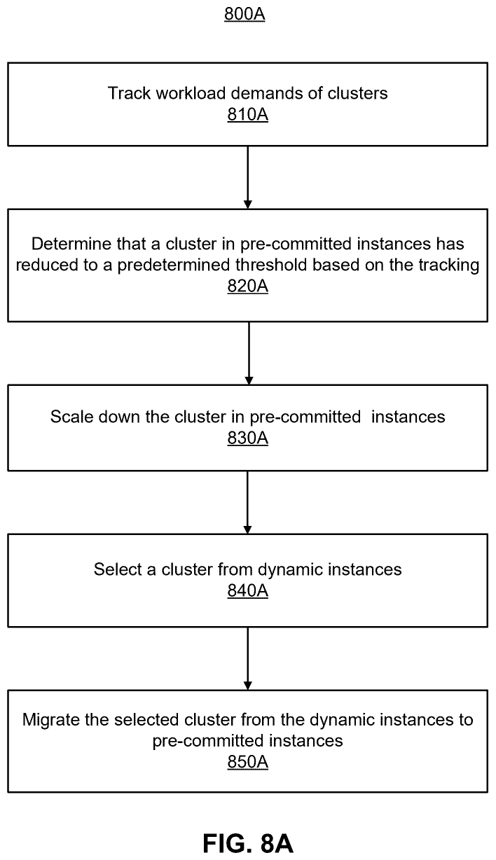

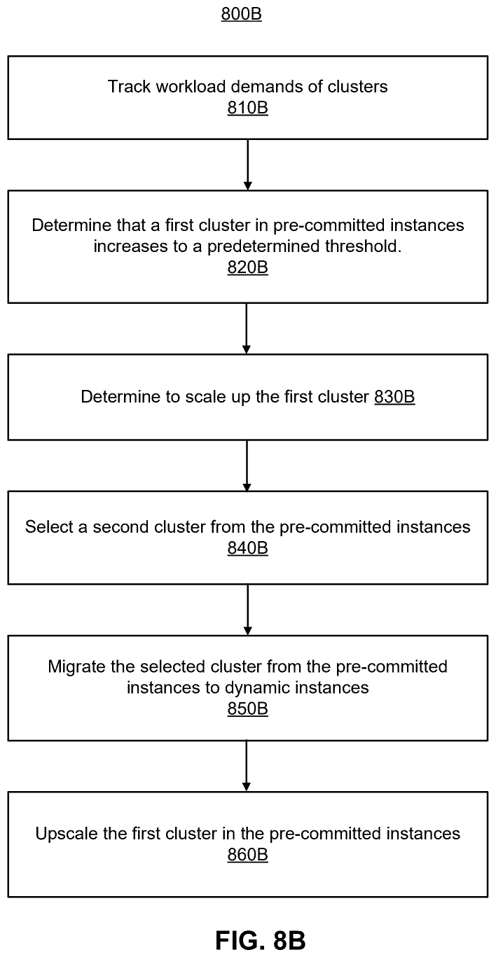

FIG. 8A is a flowchart of a method 800A for autoscaling down a cluster in a pre-committed instances in accordance with one or more embodiments. The method 800A may be performed by computing system, such as a resource management system 110. In some embodiments, the method 800A may include more or fewer steps than illustrated in FIG. 8A, and the steps of the method do not need to follow any predetermined order.

The resource management system 110 tracks 810A workload demands of clusters. In some embodiments, the system 110 monitors performance metrics of each cluster to determine workload demands. These performance metrics may include CPU utilization, memory usage, network traffic, and/or application-specific metrics (e.g., request rates, queue lengths, response times). The system 110 analyzes these metrics to determine whether a cluster is experiencing a high or low workload.

The resource management system 110 determines 820A that workload demands in a cluster in pre-committed instances has reduced to a predetermined threshold based on the tracking. In response to determining that workload demands in the cluster has reduced to the predetermined threshold, the system 110 scales 830A down the cluster in the pre-committee instances, thereby freeing up compute resources in the pre-committed instances.

The resource management system 110 selects 840A a cluster from dynamic instances. The resource management system 110 migrates 850A the selected cluster from dynamic instances to pre-committed instances, thereby freeing up at least a portion of the dynamic instances. In some embodiments, the selection of the cluster may be based on the priorities of the clusters, with higher-priority clusters being selected first. Alternatively, or in addition, the selection may be based on the size of the cluster. A cluster may be selected only if its size is smaller than the available underutilized pre-committed instances.

The method 800A may be carried out when overall workload demands are decreasing. For instance, referring back to FIGS. 6A and 6B, after 7 PM, the workload demands of clusters in the pre-committed instances decline. At this point, some clusters running in dynamic instances (e.g., on-demand instances and/or spot instances) may be migrated to the pre-committed instances to ensure they remain fully utilized.

FIG. 8B is a flowchart of a method 800A for autoscaling up a cluster in a pre-committed instances, in accordance with one or more embodiments. The method 800B may be performed by computing system, such as a resource management system 110. In some embodiments, the method 800B may include more or fewer steps than illustrated in FIG. 8B, and the steps of the method do not need to follow any predetermined order.

The resource management system 110 tracks 810B workload demands of clusters. The resource management system 110 determines 820B that a first cluster in pre-committed instances increases to a predetermined threshold. The resource management system 110 determines 830B to scale up the first cluster in the pre-committed instances, rather than in dynamic instances, potentially because the first cluster has a high priority. As previously described, the pre-committed instances may now be occupied by lower-priority clusters, leaving insufficient compute resources to scale up the first cluster.

The resource management system 110 selects 840B a second cluster in the pre-committed instances. In some embodiments, the second cluster may be selected based on the priorities of the clusters in the pre-committed instances. For example, the second cluster may have a lower priority. Alternatively, the second cluster may be selected based on its size. For example, the second cluster may have a size that is greater than the required compute resources to scale up the first cluster. The resource management system 110 migrates 850B the selected cluster from the pre-committed instances to dynamic instances, and upscales 860B the first cluster in the pre-committed instances.

The method 800B may be carried out when overall workload demands are increasing. For instance, referring back to FIGS. 6A and 6B, starting from 6 AM, the workload demands of clusters in the pre-committed instances increase. At this point, some clusters running in pre-committed instances may be migrated to the dynamic instances (e.g., on-demand instances and/or spot instances) to ensure high priority clusters have sufficient compute resources in the pre-committed instances.

### Example Computing System

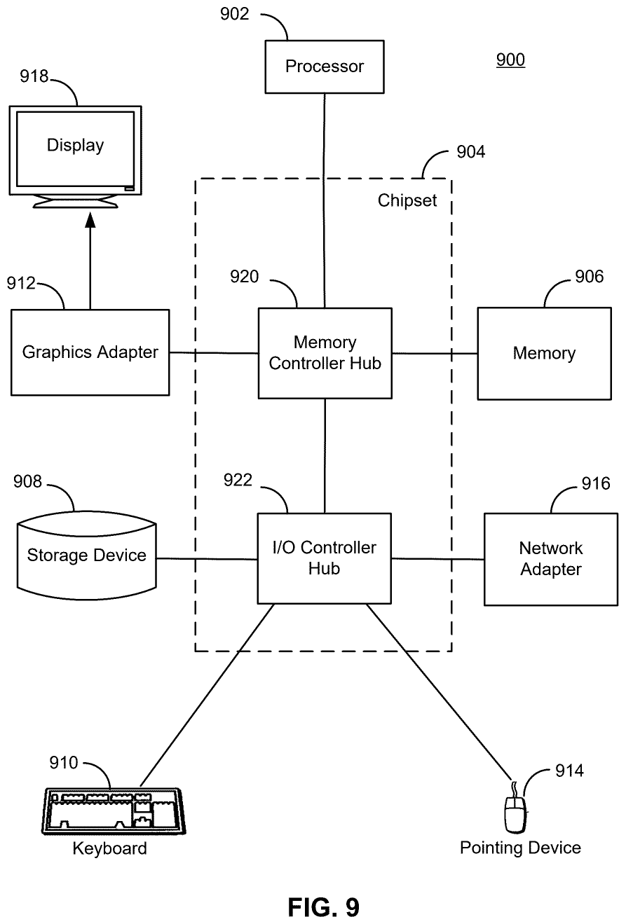

FIG. 9 is a block diagram of an example computer 900 suitable for use in the networked computing environment 100 of FIG. 1. The computer 900 is a computer system and is configured to perform specific functions as described herein. For example, the specific functions corresponding to resource management system 110 may be configured through the computer 900.

The example computer 900 includes a processor system having one or more processors 902 coupled to a chipset 904. The chipset 904 includes a memory controller hub 920 and an input/output (I/O) controller hub 922. A memory system having one or more memories 906 and a graphics adapter 912 are coupled to the memory controller hub 920, and a display 918 is coupled to the graphics adapter 912. A storage device 908, keyboard 910, pointing device 914, and network adapter 916 are coupled to the I/O controller hub 922. Other embodiments of the computer 900 have different architectures.

In the embodiment shown in FIG. 9, the storage device 908 is a non-transitory computer-readable storage medium such as a hard drive, compact disk read-only memory (CD-ROM), DVD, or a solid-state memory device. The memory 906 holds instructions and data used by the processor 902. The pointing device 914 is a mouse, track ball, touchscreen, or other types of a pointing device and may be used in combination with the keyboard 910 (which may be an on-screen keyboard) to input data into the computer 900. The graphics adapter 912 displays images and other information on the display 918. The network adapter 916 couples the computer 900 to one or more computer networks, such as network 140.

The types of computers used by the entities and the resource management system 110 of FIGS. 1 through 8 can vary depending upon the embodiment and the processing power required by the enterprise. For example, the resource management system 110 might include multiple blade servers working together to provide the functionality described. Furthermore, the computers can lack some of the components described above, such as keyboards 910, graphics adapters 912, and displays 918.

### ADDITIONAL CONSIDERATIONS

The resource management system 110, as described, provides technical improvements in cloud resource management by automating resource allocation, scaling, and rebalancing based on real-time demand. This ensures optimal utilization of pre-committed instances and reduces the need for allocating dynamic resources. As a result, the system enhances performance, scalability, and cost efficiency in cloud environments.

In particular, the system 110 enables full utilization of pre-committed instances by dynamically migrating clusters from dynamic instances (e.g., on-demand or spot instances) to pre-committed instances when workloads decrease. This prevents the common issue of underutilized pre-committed resources, which remain allocated regardless of usage. Additionally, the system's ability to scale and rebalance clusters between pre-committed and dynamic instances in real-time based on demand improves cloud resource efficiency, ensuring that high-priority clusters receive the necessary resources while minimizing reliance on dynamic instances.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcodes, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for optimizing cloud computing resource utilization in a Kubernetes environment, comprising:
allocating different types of cloud resources to different clusters in the Kubernetes environment based on priorities of the clusters, the different types of cloud resources including pre-committed instances and dynamic instances provided by one or more cloud service providers;
tracking utilization of the pre-committed instances by the clusters to determine whether the pre-committed instances are underutilized; and
responsive to determining that the pre-committed instances are underutilized, rebalancing the clusters between the pre-committed instances and the dynamic instances based on the priorities of the clusters, wherein rebalancing the clusters includes migrating at least one cluster from the dynamic instances to underutilized pre-committed instances, thereby releasing at least a portion of previously allocated dynamic instances.

2. The method of claim 1, wherein the dynamic instances comprise one or more of on-demand instances and spot instances.

3. The method of claim 1, further comprising assigning a priority to each of the clusters, wherein a first cluster with a higher priority is allocated to the pre-committed instances, and a second cluster with a lower priority is allocated to the dynamic instances.

4. The method of claim 3, wherein assigning a priority to each of the clusters comprises:
receiving a user input, indicating a priority of a cluster; and
assigning the cluster the priority indicated by the user input.

5. The method of claim 1, wherein rebalancing the clusters includes migrating a lower-priority cluster from the dynamic instances to the underutilized pre-committed instances.

6. The method of claim 1, further comprising:
responsive to determining to scaling up or scaling down the cluster, rebalancing the clusters between the pre-committed instances and the dynamic instances based on the priorities of the clusters.

7. The method of claim 6, wherein automatically scaling down a cluster allocated in the pre-committed instances based on reduced workload demands of the cluster includes:
responsive to determining to scaling down the cluster,
migrating at least one cluster in the dynamic instances to the pre-committed instances.

8. The method of claim 6, wherein automatically scaling up a first cluster allocated in the pre-committed instances based on increased workload demands of the cluster comprises:
responsive to determining to scaling up the cluster, migrating a second cluster from the pre-committed instances to dynamic instances to free up compute resource in the pre-committed instances; and
scaling up the cluster in the pre-committed instances.

9. The method of claim 8, wherein the first cluster has a higher priority than a priority of the second cluster.

10. The method of claim 6, wherein automatically scaling up a cluster allocated in the dynamic instances based on increased workload demands of the cluster comprises:
rebalancing the clusters between the pre-committed instances and dynamic instances by migrating the cluster from the dynamic instances to the underutilized pre-committed instances; and
scaling up the cluster in pre-committed instances.

11. The method of claim 10, wherein the cluster has a lower priority than another cluster in the pre-committed instances.

12. The method of claim 1, further comprising:
determining to scale up a cluster in the dynamic instances based on increased workload demands of the cluster; and
allocating additional cloud resources from the underutilized pre-committed instances to scaling up the cluster.

13. A non-transitory computer readable storage medium having instructions encoded thereon that, when executed by one or more processors, cause the one or more processors to perform steps including:
allocating different types of cloud resources to different clusters in a Kubernetes environment based on priorities of the clusters, the different types of cloud resources including pre-committed instances and dynamic instances provided by one or more cloud service providers;
tracking utilization of the pre-committed instances by the clusters to determine whether the pre-committed instances are underutilized; and
responsive to determining that the pre-committed instances are underutilized, rebalancing the clusters between the pre-committed instances and the dynamic instances based on the priorities of the clusters, wherein rebalancing the clusters includes migrating at least one cluster from the dynamic instances to underutilized pre-committed instances, thereby releasing at least a portion of previously allocated dynamic instances.

14. The non-transitory computer readable storage medium of claim 13, wherein dynamic instances include on-demand instances and spot instances.

15. The non-transitory computer readable storage medium of claim 13, wherein the different clusters are Kubernetes clusters in a Kubernetes environment.

16. The non-transitory computer readable storage medium of claim 13, wherein the one or more processors are further caused to:
assign a priority to each of the clusters, wherein a first cluster with a higher priority is allocated to the pre-committed instances, and a second cluster with a lower priority is allocated to dynamic instances.

17. The non-transitory computer readable storage medium of claim 16, wherein assigning a priority to each of the clusters comprises:
receiving a user input, indicating a priority of a cluster; and
assigning the cluster the priority indicated by the user input.

18. The non-transitory computer readable storage medium of claim 13, wherein rebalancing clusters includes migrating a lower-priority cluster from the dynamic instances to the underutilized pre-committed instances.

19. The non-transitory computer readable storage medium of claim 18, wherein the one or more processors are further caused to:
responsive to determining to scaling up or scaling down the cluster, rebalancing the clusters between the pre-committed instances and the dynamic instances based on the priorities of the clusters.

20. A computing system, comprising:
one or more processors; and
a non-transitory computer readable storage medium having instructions encoded thereon that, when executed by the one or more processors, cause the one or more processors to perform steps including:
allocating different types of cloud resources to different clusters in a Kubernetes environment based on priorities of the clusters, the different types of cloud resources including pre-committed instances and dynamic instances provided by one or more cloud service providers;
tracking utilization of the pre-committed instances by the clusters to determine whether the pre-committed instances are underutilized; and
responsive to determining that the pre-committed instances are underutilized, rebalancing the clusters between the pre-committed instances and the dynamic instances based on the priorities of the clusters, wherein rebalancing the clusters includes migrating at least one cluster from the dynamic instances to underutilized pre-committed instances, thereby releasing at least a portion of previously allocated dynamic instances.
